(19) United States
(12) Patent Application Publication
(10) Pub. No.: US 2016/0071041 A1
(43) Pub. Date: Mar. 10, 2016

(54) EVALUATING ENERGY SAVING IMPROVEMENTS

(71) Applicant: Empowered Energy Solutions, Inc., San Diego, CA (US)

(72) Inventor: Jose de la Torre Bueno, Vista, CA (US)

(73) Assignee: Empowered Energy Solutions, Inc., San Diego, CA (US)

(21) Appl. No.: 14/880,062

(22) Filed: Oct. 9, 2015

Related U.S. Application Data
(63) Continuation of application No. 13/949,563, filed on Jul. 24, 2013, now abandoned.
Application No. 13/949,563 is a continuation of application No. 12/768,243, filed on Apr. 27, 2010, now abandoned.
(60) Provisional application No. 61/172,992, filed on Apr. 27, 2009.

(51) Int. Cl. G06Q 10/06; G06Q 50/16

(52) U.S. Cl. CPC G06Q 10/06313; G06Q 50/163; G06Q 10/067

(57) ABSTRACT

A computer is used for obtaining information about a plural number of energy-saving measures. This can include information about costs of combinations of said energy-saving measures, said costs include first information about costs of making the measures, second information about rebates for the measures, and third information about energy-saving that will occur from the measures, where at least some of said third information will depend on said combinations of said energy-saving measures. An iterative algorithm is used which determines combinations and which determines which of the combinations produce maximum savings by combinations of the said first, second and third information. A report can be created.

### CROSS REFERENCE TO RELATED APPLICATIONS

This application claims the benefit of U.S. patent application Ser. No. 13/949,563, filed Jul. 24, 2013, which claims priority to U.S. patent application Ser. No. 12/768,243 filed Apr. 27, 2010, which claims priority to U.S. Provisional Application No. 61/172,992, filed Apr. 27, 2009, each of which is hereby incorporated in its entirety including all tables, figures and claims.

### BACKGROUND

There are many steps an owner can take to reduce the energy and utility costs associated with operating a building. Even a partial list of steps raises a bewildering number of alternatives. For instance:

Add solar electric panels

Add solar hot water panels (for hot water only or for building heat as well)

Replace lamps and or light bulbs with higher efficiency units.

Replace appliances with higher efficiency models.

Add insulation in the attic.

Add insulation in the walls.

Paint the roof white.

Replace some or all of the windows.

Weatherstrip the windows and doors.

Add awnings.

Replace HVAC systems.

Replace lighting with higher efficiency models.

Determining whether any single one of these changes in isolation is cost effective in terms of internal rate of return for a given cost of money is a difficult but perhaps solvable problem.

### SUMMARY

The present application describes a computer program that addresses this problem, but obtaining information about a plural number of energy-saving measures; and determines information about costs of combinations of said energy-saving measures, said costs include first information about costs of making the measures, second information about rebates for the measures, and third information about energy-saving for the measures, where at least some of said third information said third information will depend on said combinations of said energy-saving measures; running an iterative algorithm which determines combinations and which determines which of said combinations produce maximum savings by combinations of the said first, second and third information; and producing a report indicative of an ideal combination.

### BRIEF DESCRIPTION OF THE DRAWINGS

FIG. 1 shows a flowchart of operation;

FIG. 2 shows a computer that can be used according to the present system.

### DETAILED DESCRIPTION

Commercial software exists which can calculate the energy required to heat and cool a structure. Other commercial software is known which can take into account local climate and orientation of a structure.

This information can be combined to calculate energy savings from any particular energy improvement which could be done.

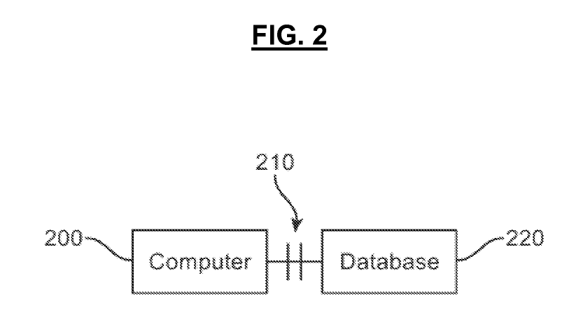

An embodiment describes a computer program running on the computer of the types shown in FIG. 2. That computer programs stores multiple different databases or files of information. A first file of information may include information about energy savings, for example information of the local utility rates. Another file might include information about costs for a number of different energy-saving changes. Yet another file might include rebate information, for example what incentives are available in the jurisdiction for that building type and other information. For example, some of the incentives may be time limited, or may apply only to certain kinds of items. For example, there may be credits that may apply in certain time frames, or credits that may apply only when certain conditions are carried out. One example of the latter is a clunker rebate, where an item such as a refrigerator or air conditioner receives a rebate only if it is used to replace an otherwise working, but less energy-efficient, item.

In a first embodiment, the cost to execute any one item and the cost savings for that any one item can be calculated. This can provide an objective answer as to the actual return for any given modification.

However, this may only be part of the analysis, since this assumes a wholly financially motivated buyer. If altruistic considerations, such as reducing one's carbon footprint, are included, the buyer may make decisions that could not be justified on purely economic grounds. Hence, the environmental consciousness of the user might also be taken into account. Yet another intangible might be the public relations issue, for example commercial properties might be better perceived if they are “green” even if other parameters did not render this financially sensible. These “other” parameters are difficult to quantify.

Even if the “other” parameters are the reason that the user would do something, it would be likely that the user still would want to make the maximum reduction in their carbon footprint possible with their available budget. In addition, even those with altruistic bases may want to know how much this is going to cost them. For these reasons, the cost analysis is important no matter what the motivation. Accordingly, discussion in this application referring to cost refers not just to cost, but also to altruistic motivations, and all other similar motivations.

Another embodiment is based on the inventors' recognition that the more realistic requirement is not to identify a single modification but to determine a set of modifications that would provide the best return on investment. An embodiment describes identifying and evaluating the proposed modifications as a group, rather than in in isolation because there are many interactions which should be considered to determine which subset of a group of possible modifications would be most cost effective.

Embodiments describe some of the many interactions that may be considered. While some of these are listed below, it should be understood that other embodiments may consider other interactions.

Heat flow through the envelope of a building occurs in parallel through the various components, and resistances in parallel add as the reciprocal of the sum of the reciprocals. That is: Rtotat=1/(1/R1+1/R2). Because of this, adding insulation in any one location may have little effect. Ideally, all thermal resistance should be reduced proportionally. On the other hand, some areas may be much more expensive to insulate than others, so it is necessary to evaluate many different combinations of partial insulation to find the cost effective optimal combination. This is done, for example, by evaluating geometrically areas of the building, and determining how partial insulation can provide the most cost effective optimal installation. The optimum combination of improvements may take into effect this effect. The database may for example indicate that insulating only in certain areas while not insulating in other areas may have no real effect.

Some modifications may make others moot or at least non cost effective. For instance, it may be cost effective to add an awning over a window or replace it with one with low-e glass, but it may not be cost effective to do both. Again, one of the databases may include information which indicates that only one of certain things should be done. The database also may take into account how some modifications may moot other modifications.

These interactions are referred to herein as being “nonlinear” in the sense that the combination of these effects do not linearly add up to their result. For example, insulating half to house may have an effective the heat insulation result of 1%, but insulating the whole house may insulate bt 30%. Two times the 1% would only be 2%, but the synergistic effect of multiple different items is different than their additive result.

The database may also take into account other scenarios described throughout the specification.

In some climates, when specifying a solar electric system it may be more cost effective to spend money to reduce the A/C load by improving the insulation and thereby reduce the size of the solar system specified.

Investments to change a fuel source, such as converting from oil to wood pellets, may or may not be cost effective depending on to cost of the steps that might be taken to reduce heat loss and the local climate

The cost effectiveness of replacing an A/C compressor will depend on the relative cost of improving a building's insulation as well as the reduction in internal heat load achieved with more efficient lights and appliances.

It may be necessary to choose between different incentive schemes. Frequently, some incentives offered by government agencies or utilities are at least partially mutually exclusive. Since they may cover different improvements it may be necessary to evaluate different combinations of improvements combined with different combinations of available incentives.

Although it may be feasible to imagine running an energy analysis program twice to check the impact of a single change, it is simply not computationally feasible to check every possible combination out of a list of possible changes. To do so would require running the energy model program repeatedly with far too many combinations to give an optimal result in a reasonable time.

Consider a very simplified case in which there is a building with four walls and a roof. The roof and walls could be insulated or not at different costs, with two or more possible grades of insulation with different R values. The windows on four exposures could be left as they are or replaced with two different types of upgraded windows and/or have an awning added. There are two possible sizes of solar systems, or none at all.

To evaluate even this simplified example by trying all the various combinations in an energy analysis program or model will lead to an unacceptable number of runs. In the example given there are 35×(3×2)4×3 or 944,784 possible combinations. Further, this is an example of the class of problems in which the number of alternatives increases exponentially with the complexity. Consider the same problem with the added possibility that the air conditioning system might be replaced. There are now 35×(3×2)4×3×2 or 1,889,568 combinations. That is to say, going from 10 factors (4 walls, the roof, 4 windows and the solar system) to 11 factors increased the computational cost by a factor of two rather than 10%.

The simple answer to the question, “how are optimal combinations of improvements being selected now?” is that it is not being optimized at all. The inventors recognize that part of this is due to the fragmentation of the industry. A contractor who is licensed to deliver a certain service, say solar panel installation, has no economic incentive to tell customers to get an insulation contractor first and see how much the electric bill is reduced before sizing a solar electric system.

A combinatorial problem of this type can be simplified if there are known sub-combinations that are always desirable or undesirable. For instance, as a rule of thumb, replacing commonly used lights with compact fluorescents is likely to be part of any optimized list. By making assumptions of this type the problem can be simplified at the expense of possibly arriving at sub-optimal solutions. In this example, the statement that compact fluorescents are always a cost effective change is no longer true because newer LED based lights may be more cost effective depending on how often the light is used and how hard it is to replace.

Virtually all books and websites advising homeowners are, in effect, rules of thumb like this. It is possible to make up a list of potential changes in the order estimated or likely cost effectiveness. This in effect represents the judgment calls of somebody who presumably has some experience with modifying many buildings and recalls the results. The inventors believe, however that the many reasons and heuristic rules cannot not lead to optimal selections of improvements. In the first place, even an experienced contractor will have done at most a few dozen to a hundred houses each of which is different, so valid generalizations will be hard to make. Secondly, the optimum combinations of improvements will depend on the existing energy saving features of the building, the climate, the available incentives in the jurisdiction, the current local costs of improvements, the local cost of energy and the owners effective interest cost. Finally, these factors can change instantly; changes in technology or pricing and the initiation and closing of rebates or incentives can change the optimal strategy from one day to the next.

For all these reasons, decisions on which improvements to make are currently guesses at best. In part, the inability to truly optimize decisions on improving the energy of buildings is currently mitigated by the fact that most US buildings are so energy inefficient that almost any combination(s) of energy saving measures is certain to be an improvement even it was not the optimal combinations of improvements. Additionally, early adopters of energy efficiency and solar power were often making the changes at least in part for environmental or altruistic reasons, so extracting the absolutely maximum financial return from their investment was not a mandatory part of the project.

Going forward, more owners will be making decisions to invest in energy saving measures for financial reasons. These users will expect projects to be designed to have the maximum return on investment and to utilize all available rebates and incentives in the way that maximizes their return.

As described above, exhaustively testing all combinations of possible improvements may not be economically and/or computationally feasible, while using general guidelines and rules of thumb is likely to arrive at sub-optimal solutions.

The problem is to explore the space of possible combinations of improvements in a way that is computationally efficient and will generate the best solution that can be found in an efficient manner. Any given proposed set of improvements can be evaluated using existing energy modeling software, a database of available and potentially temporally dynamic incentives which can be searched for all incentives applicable to the project, and standard financial models which will generate a net present value for the given improvements.

For any set of improvements, this analysis will therefore generate a figure of merit or fitness function. The problem is to find the combination of improvements and incentives that maximize this function without having to exhaustively try all combinations in the solution search space.

The inventors recognize that different kind of solutions to exploring complex solution spaces in an efficient way can be used to solve this problem. One technique uses evolutionary algorithms. An evolutionary algorithm presupposes a method of evaluating a proposed solution to assigning a figure of merit, but does not require any other algorithm that can explicitly solve for an optimal solution.

One procedure to find a solution using an evolutionary algorithm is as follows:

A number (e.g., 100 to 1000) of possible combinations are generated at random.

All the possible combinations are evaluated with the figure of merit algorithm.

The best few percent of the population of solutions are retained to generate a next generation of solutions. This is the mathematical analogue of natural selection.

The next generation of possible solutions is created by randomly combining elements of the best of the previous generation. This is a mathematical analog of sexual reproduction.

Optionally random changes are introduced into at least some of the new population. This is the mathematical analogue of mutation.

Steps 2 to 5 are repeated iteratively, e.g., a few hundred to a few thousand times.

The iterative process terminates when an exit criterion (or criteria) are met. These may include the total number of iterations, the cumulative number of function evaluations, the current rate of performance improvement, or a specified amount of computational processing time.

It has been demonstrated in other fields that the quality of the best potential solutions found by this seemingly random procedure will rise with successive generations and eventually reach an asymptote. The best solution (combination of improvements) is found when the procedure stops. This is not necessarily the best of all possible solutions, but it will almost always be a good solution since in the evolutionary algorithm the solution quality improves monotonically, and the number of potential solutions which need to be tested to find it will be a tiny fraction of the number of combinations which would have to be tested to find the optimal solution by exhaustive search.

An evaluation function as described above is used to determine the relative worth of each possible combination of improvements generated by the evolutionary algorithm. To carry out this calculation the function uses several classes of data as follows:

Data on the specific structure to be improved collected in an initial survey. This data can include but is not limited to:

The physical dimensions, exposure and facing of each exterior wall

The current type and value of the insulation in each wall, if any

The physical dimension of the roof

The type of roof insulation

The type of roof treatment

The area of windows at each facing direction and their type, weatherstripping and U value.

The type and rating of the A/C unit

The type and rating of the heating unit

The method of distribution of HVAC and any insulation on the pipes or ducts

The number and wattage of all lights and the approximate hours they are operated.

Enough of the owner's financial data to calculate the potential value of tax rebates and the likely finance cost of improvements.

The databases described above can include:

A database of rebates and incentives, giving the current rates and eligibility limits for each incentive and the jurisdictions in which they are available. This database should also include any data on exclusions or limitations to receiving an incentive as well as limitations on receiving more than one incentive or specific combinations of incentives.

A database of estimated unit costs for the types of improvements being contemplated. This could be from industry surveys such as mean value or could be the agreed rates negotiated with franchisees.

A database of predicted, e.g., historical, climate data. This could be a public database accessible over the internet or a private database.

Any subset of this information can alternatively be used.

Given this data, the expected financial return from any combination of energy saving or generating improvements can be calculated using existing energy evaluation programs and standard financial models. This data is used in the optimization processed by the evolutionary algorithm.

Additionally, a relaxation mechanism can be incorporated into the scoring and selection process to allow secondary criteria to be included in the optimization process. For example, solutions that may have exceeded set points for heating, cooling, and comfort (and therefore may have been selected against) can be retained as part of the population of solutions. An adaptive function is incorporated to alter the penalty weight applied to solutions that exceed desired set point (and potentially other) solution values. These penalty weights are initially set to low values (e.g., 0.0) at the start of the iterative optimization process. The penalty values increase with each successive generation of the evolutionary optimization process such that these secondary criteria become more of a factor in the selection mechanism.

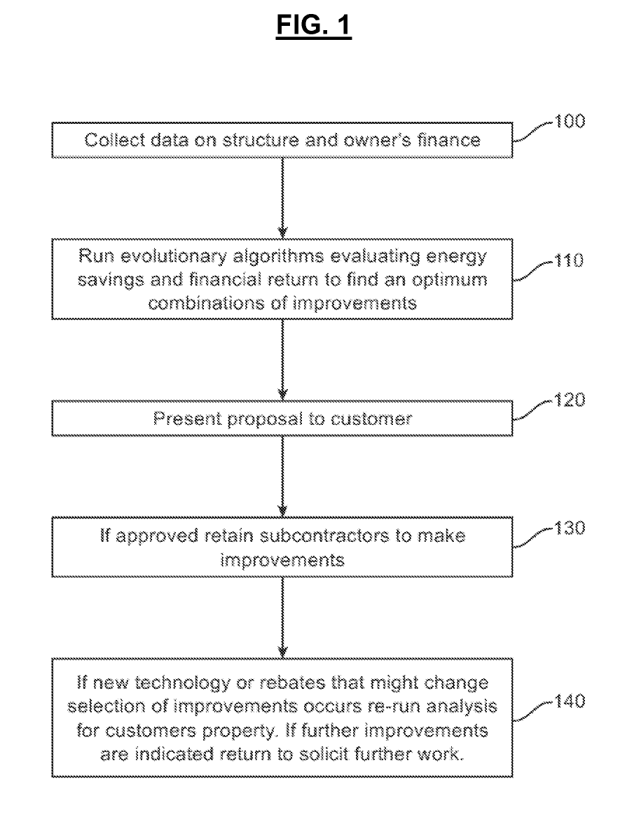

A flow chart of the use of this technique is given in FIG. 1. FIG. 1 shows, at 100, collecting the data on the structure in the owner's finances, that collects the information above. At 110, the evolutionary algorithms are drawn in order to evaluate the optimum combination. While other techniques can be used to obtain this information, the evolutionary algorithms may be one good way of determining an optimum result. At 120, the proposal is presented to the customer, and that 130, subcontractors are used to make improvements. At any time during the operation, at 140, new technology or rebates may change the value. Many of these rebates, for example, are very much be limited.

All of the operations described herein can be carried out on a general-purpose computer shown as 200 in FIG. 2. The computer has access to a database which can be an internal memory, or can, as shown, be accessible over a network such as 210. The database 220 may store data about a number of different properties in the world, data about climates for example by address or ZIP code, rebates available tied to the ZIP code and/or properties such as age of the property, and a database of cost and performance of potential improvements. The computer 200 is programmed, as described above, to evaluate combinations of improvements and calculate financial returns, using a technique that combines all of these operations.

Different actions can affect the cost in different ways. The cost savings depend, however, on the data about the climate, data about different rebates, how the rebates inter-react (for example if you get one rebate but you can't get another, or you can get stacked rebates), tax credits, description of the building, motivation of the buyer (cost or carbon footprint), proposed solution, and the like. All of these together need to be individualized for any specific situation. This data and other can be used to create the fitness function for the evolutionary algorithm. The evolutionary algorithm can also define percentage rates and types of mutation for solution variation that is used to search the space of possible solutions, as well as dynamically adapt these parameters to more efficiently search the solution space.

Other techniques can be used to solve this multivariable problem, including Monte Carlo simulations.

As an example, a user might want to spend $500 for solar cells that create 100 to 200 W of electricity during sunlit hours. However, if there are certain lightbulbs that are used very often, those lightbulbs might be replaced by high energy or high-efficiency fluorescent or LED lightbulbs for example. If these lightbulbs are on 50% of the time, replacing 4-100 W light bulbs with 8 W LED lightbulbs might have a similar energy-saving to that of installing a 200 W solar cell. However, four LED lightbulbs might cost $40, as compared with a $500 solar cell. This depends, however, on the efficiency and hours of the sunlight, the exposure, the amount of time the lights are on, and the like. Therefore, this is highly factually intensive.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other algorithms can be used to combine this information and find a solution, which can be the optimum solution per unit time or processing power as in the present system, or a true optimum solution.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor(s), a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor(s) may be a microprocessor, but in the alternative, the processor may be any conventional processor, controller, microcontroller, or state machine. The processor(s) can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor(s) may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine(s), which allows the local machine(s) to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method of efficiently generating a visual dataset of an at least partially-optimized combination of a plurality of energy-saving measures for a building without separately evaluating all possible combinations of all the energy-saving measures, comprising the steps of:
Providing a non-transitory programmable digital computer means with a processor for use in analyzing the energy-saving measures;
providing the non-transitory programmable digital computer means with a database comprising information about costs and savings of energy-saving measures for a building, said information including:
first information about costs of implementing each energy-saving measure;
and second information about cost savings resulting from implementing each energy-saving measure, wherein at least some of said second information varies depending on which energy-saving measures are combined;
causing the processor of the non-transitory programmable digital computer means to execute an evolutionary algorithm that performs at least the following steps:
in a first combining step, at least partially randomly combining at least a plurality of the energy-saving measures into a first combination and assigning that first combination a numeric indicator of merit based on the information about costs and savings of the energy-saving measures in that first combination;
repeating said first combining step a plurality of times, thereby generating a first plurality of combinations of energy-saving measures with a numeric indicator of merit assigned to each combination therein;
in a first selection step, creating a first sub-group of combinations of energy-saving measures from the first plurality of combinations of energy-saving measures, based at least in part on the numeric indicators of merit associated with each combination of energy-saving measures in the first plurality of combinations of energy-saving measures;
in a second combining step, at least partially randomly combining at least some of the energy-saving measures from the first sub-group of combinations of energy-saving measures into a second combination and assigning that second combination a numeric indicator of merit based on the information about costs and savings of the energy-saving measures in that second combination;
repeating said second combining step a plurality of times, thereby generating a second plurality of combinations of energy-saving measures with a numeric indicator of merit assigned to each combination therein;
in a second selection step, creating a second sub-group of combinations of energy-saving measures from the second plurality of combinations of energy-saving measures, based at least in part on the numeric indicators of merit associated with each combination of energy-saving measures in the second plurality of combinations of energy-saving measures;
iteratively repeating said combining and selection steps until one or more exit criteria are met; and
outputting information regarding one or more combinations of energy-saving measures based on the numeric indicators associated therewith; and
identifying one or more at least partially-optimized combinations of energy-saving measures for the building based on the information output by the evolutionary algorithm.

2. The method of claim 1, wherein the energy-saving measures include one or more of the following measures:
adding solar electric panels;
adding solar hot water panels to supply hot water;
adding solar hot water panels to supply building heat;
replacing lights with higher efficiency units;
replacing one or more appliances with higher efficiency models;
adding insulation in attic;
adding insulation in walls;
painting the roof white;
replacing one or more windows;
weather-striping windows;
weather-striping doors;
adding awnings;
replacing HVAC systems.

3. The method of claim 1, wherein the exit criteria comprise one or more of the following criterion:
the total number of iterations;
the cumulative number of function evaluations;
predetermined amount of computational processing time.

4. The method of claim 1, wherein the exit criteria are met when the numeric indicators of merit associated with immediately successive iterations increase at less than a predetermined rate.

5. The method of claim 1, wherein the first plurality of combinations comprises 100 to 1000 combinations.

6. The method of claim 1, wherein the energy-saving measures of each successive iteration of combinations are at least primarily selected from the best-performing combinations of energy-saving measures in the immediately preceding iteration, as determined by numeric indicators of merit.

7. The method of claim 6, wherein at least one of the energy-saving measures of a successive iteration of combinations is randomly selected.

8. An energy reduction system, comprising:
A non-transitory programmable digital computer means with a processor for efficiently generating a visual dataset of an at least partially-optimized combination of a plurality of energy-saving measures for a building without separately evaluating all possible combinations of all the energy-saving measures, the non-transitory programmable digital computer means adapted to receive input information about costs and savings of energy-saving measures for a building on a computer readable storage medium, said information including:
first information about costs of implementing each energy-saving measure; and
second information about cost savings resulting from implementing each energy-saving measure, wherein at least some of said second information varies depending on which energy-saving measures are combined;the non-transitory programmable digital computer means specially programmed and adapted for the processor to execute an evolutionary algorithm and access the computer readable storage medium to perform at least the following steps:
in a first combining step, at least partially randomly combining at least a plurality of the energy-saving measures into a first combination and assigning that first combination a numeric indicator of merit based on the information about costs and savings of the energy-saving measures in that first combination;
repeating said first combining step a plurality of times, thereby generating a first plurality of combinations of energy-saving measures with a numeric indicator of merit assigned to each combination therein;
in a first selection step, creating a first sub-group of combinations of energy-saving measures from the first plurality of combinations of energy-saving measures, based at least in part on the numeric indicators of merit associated with each combination of energy-saving measures in the first plurality of combinations of energy-saving measures;
in a second combining step, at least partially randomly combining at least some of the energy-saving measures from the first sub-group of combinations of energy-saving measures into a second combination and assigning that second combination a numeric indicator of merit based on the information about costs and savings of the energy-saving measures in that second combination;
repeating said second combining step a plurality of times, thereby generating a second plurality of combinations of energy-saving measures with a numeric indicator of merit assigned to each combination therein;
in a second selection step, creating a second sub-group of combinations of energy-saving measures from the second plurality of combinations of energy-saving measures, based at least in part on the numeric indicators of merit associated with each combination of energy-saving measures in the second plurality of combinations of energy-saving measures;
iteratively repeating said combining and selection steps until one or more exit criteria are met; and
outputting information regarding one or more combinations of energy-saving measures based on the numeric indicators associated therewith;
a user interface adapted to facilitate communication of information between a user and the programmable digital computer means;
whereby the energy reduction system is adapted to allow a user of the system to identify one or more at least partially-optimized combinations of energy-saving measures for the building based on the information output by the evolutionary algorithm.

9. The system of claim 8, wherein the energy-saving measures include one or more of the following measures:
adding solar electric panels;
adding solar hot water panels to supply hot water;
adding solar hot water panels to supply building heat;
replacing lights with higher efficiency units;
replacing one or more appliances with higher efficiency models;
adding insulation in attic;
adding insulation in walls;
painting the roof white;
replacing one or more windows;
weather-striping windows;
weather-striping doors; adding awnings;
replacing HVAC systems.

10. The system of claim 8, wherein the exit criteria comprise one or more of the following criterion:
the total number of iterations;
the cumulative number of function evaluations;
a predetermined amount of computational processing time.

11. The system of claim 8, wherein the exit criteria are met when the numeric indicators of merit associated with immediately successive iterations increase at less than a predetermined rate.

12. The system of claim 8, wherein the first plurality of combinations comprises 100 to 1000 combinations.

13. The system of claim 8, wherein the energy-saving measures of each successive iteration of combinations are at least primarily selected from the best-performing combinations of energy-saving measures in the immediately preceding iteration, as determined by numeric indicators of merit.

14. The system of claim 8, wherein at least one of the energy-saving measures of a successive iteration of combinations is randomly selected.

15. The method of claim 1 wherein the information in a database comprising information about costs and savings of energy-saving measures for a building includes third information about rebates that may be available as a result of implementing each energy-saving measure;

16. The system of claim 8 the information in a database comprising information about costs and savings of energy-saving measures for a building includes third information about rebates that may be available as a result of implementing each energy-saving measure;
